(19) United States
(12) Patent Application Publication
(10) Pub. No.: US 2023/0235773 A1
(43) Pub. Date: Jul. 27, 2023

(54) CLINCH FASTENER

(71) Applicant: Acument Intellectual Properties, LLC, Sterling Heights, MI (US)

(72) Inventors: Steven P. Donovan, Roscoe, IL (US); Bryan D. Warju, II, Lake Orion, MI (US)

(73) Assignee: Acument Intellectual Properties, LLC, Sterling Heights, MI (US)

(21) Appl. No.: 18/190,757

(22) Filed: Mar. 27, 2023

Related U.S. Application Data
(63) Continuation-in-part of application No. 16/737,041, filed on Jan. 8, 2020, now Pat. No. 11,614,118.
(60) Provisional application No. 62/789,880, filed on Jan. 8, 2019.

(51) Int. Cl. F16B 35/06; F16B 33/00; F16B 37/06

(52) U.S. Cl. CPC F16B 35/06; F16B 33/002; F16B 37/068

(57) ABSTRACT

A clinch fastener includes a shaft defining a central axis and a head having an outer periphery cooperating with the shaft. A plurality of ribs disposed under the head to engage a workpiece. The plurality of ribs extending radially outward in a direction from a displacement collar positioned proximate the central axis of the clinch fastener to the outer periphery of the head. Each of the plurality of ribs includes multiple sections forming at least a sidewall and a parametric profile for each rib. The clinch fastener includes a retaining ring cooperating with the shaft and a retaining groove cooperating with the shaft positioned between the displacement collar and retaining ring. The plurality of ribs and displacement collar are configured to radially displace workplace material into the retaining groove and diffuse stress within the workpiece material when the fastener is secured to the workpiece.

### CROSS REFERENCE TO RELATED APPLICATIONS

This application is a continuation-in-part of U.S. application Ser. No. 16/737,041, filed on Jan. 8, 2020, which claims the benefit of U.S. Provisional Application Ser. No. 62/789,880, filed on Jan. 8, 2019, wherein both applications are hereby incorporated herein by reference in their entirety.

### INTRODUCTION

Clinch fasteners are widely known in the fastener industry, and come in many different forms such as nuts, studs, pins, standoffs, etc. Regardless of the exact form, during installation a clinch fastener is typically pressed into a round mounting hole that has been pre-formed in a workpiece. The workpiece is formed of a host material that is ductile and softer than the clinch fastener. Once the clinch fastener has been properly installed, the clinch fastener is prevented from rotating relative to the host material, and axial movement is also prevented. Thus, once installed, a clinch fastener effectively becomes a permanent part of the workpiece.

Clinch fasteners are used in certain applications because they provide several advantages. For example, typically clinch fasteners are more reliable and provide increased retention compared to either stamped or tapped threads. Clinch fasteners are used in applications where sufficient pushout/pullout (i.e., axial retention load) and torque are required in sheet metal that is too thin and/or too ductile to provide secure fastening by any other suitable method. Even in applications where the sheet metal would be sufficiently thick to allow for thread tapping, using threaded clinch fasteners instead of tapping the threads into the sheet metal is oftentimes the more economical choice. Clinch fasteners can be installed during fabrication to eliminate loose hardware during final assembly. Furthermore, using clinch fasteners often allows for the use of thinner sheet metal as well as providing for a neat appearance as a result of their compact design and low profile.

Clinch fasteners are often used in applications where a component must be readily replaced, and where loose hardware will not be accessible. Because clinch fasteners can be installed during metal fabrication, they can simplify and expedite component mounting and assembly operations, including those performed in the field.

As discussed above, when a clinch fastener is installed by pressing it into a mounting hole in a workpiece (such as in sheet metal), the clinch fastener displaces the host material around the mounting hole, causing the host material to cold flow into an annular recess or undercut in the clinch fastener. The installation of a clinch fastener often results in high stress areas in the host material (typically under a head of the fastener), sometimes to the extent that there is either warping of the workpiece, where the joint is adversely impacted, or the clinch fastener ends up not being perpendicular to the workpiece after installation (i.e., the clinch fastener is cock-eyed or crooked).

### SUMMARY

A clinch fastener for installation relative to a workpiece is described. The clinch fastener includes a plurality of ribs disposed under the head of the clinch fastener, wherein the ribs are specifically configured to displace host material more evenly than conventional clinch fasteners. To that end, in cross section, along a line going from a central axis of the clinch fastener to an outer periphery of the head of the clinch fastener, each rib preferably provides a curved surface that is formed of multiple sections, wherein different radii or line segments define each of the sections. Preferably, the ribs diminish in height as they extend to the outer periphery of the head of the clinch fastener. Additionally, preferably the ribs are equally spaced apart under the head, but that is not imperative.

An aspect of the disclosure is to provide a clinch fastener that is configured to provide for a more uniform stress distribution in the host material.

The clinch fastener includes a shaft defining a central axis of the clinch fastener and a head cooperating with the shaft, the head having an outer periphery. A plurality of ribs disposed under the head to engage the workpiece upon installation of the clinch fastener to the workpiece, the plurality of ribs extending radially outward in a direction from a displacement collar positioned proximate the central axis of the clinch fastener to the outer periphery of the head. Each of the plurality of ribs includes multiple sections forming at least a sidewall and a parametric profile for each rib, including at least a first section disposed proximate the shaft extending perpendicular to the central axis and an outer end adjacent the outer periphery of the head.

The clinch fastener includes a retaining ring cooperating with the shaft and a retaining groove cooperating with the shaft positioned between the displacement collar and retaining ring. The plurality of ribs and displacement collar are configured to radially displace workplace material into the retaining groove and diffuse stress within the workpiece material when the fastener is secured to the workpiece.

An aspect of the disclosure includes at least two of the sections defined by different radii or a plurality of line segments.

Another aspect of the disclosure includes at least two of the sections are flat, and at least one is parallel to the head.

Yet another aspect of the disclosure includes each of the ribs diminish in height and increase in width as each of the ribs extends in a direction going from the central axis of the clinch fastener to the outer periphery of the head of the clinch fastener.

In yet another aspect of the disclosure includes each of the ribs diminish in height and remain uniform in width as each of the ribs extends in a direction going from the central axis of the clinch fastener to the outer periphery of the head of the clinch fastener.

An aspect of the disclosure includes the ribs are equally spaced apart under the head.

Another aspect of the disclosure includes the ribs are unequally spaced apart under the head.

Yet another aspect of the disclosure includes the retaining groove is positioned proximate the plurality of ribs under the head, and includes an annular recess proximate the ribs, disposed between the head and the shaft.

An aspect of the disclosure includes the clinch fastener comprises a nut having a threaded bore.

Another aspect of the disclosure includes each of the plurality of ribs commences with a section that is perpendicular to the central axis of the clinch fastener, and a remainder of each rib comprises a plurality of sections, wherein at least two of the sections are curved and defined by different radii or a plurality of line segments.

Yet another aspect of the disclosure includes each of the plurality of ribs commences with a section that is perpendicular to the central axis of the clinch fastener, wherein each rib has at least one section that is curved and one section that is flat.

An aspect of the disclosure includes each of the plurality of ribs comprises a plurality of flat sections that collectively provide that the rib diminishes in height as the rib extends to the outer periphery of the head.

Another aspect of the disclosure includes each of the plurality of ribs comprises tapered sidewalls.

Yet another aspect of the disclosure includes each of the plurality of ribs comprises outwardly tapered sidewalls.

An aspect of the disclosure includes the plurality of ribs are configured to provide for reduced warping of the workpiece material during installation as a result of the plurality of ribs being configured to provide for radially focused material displacement of workpiece material resulting from a taper on a sidewall of each of the ribs.

Another aspect of the disclosure includes wherein each of the plurality of ribs commences with a section that is perpendicular to the central axis of the clinch fastener, and a remainder of each rib comprises a plurality of sections, and wherein the plurality of sections form the parametric profile of the plurality of ribs.

Yet another aspect of the disclosure includes the parametric profile of each of the plurality of ribs is defined by a plurality of parameters including a rib height, a distance from a central axis of the clinch fastener to an end of the rib, and a predefined angle Theta.

A clinch fastener for installation relative to a workpiece, the clinch fastener includes a shaft defining a central axis of the clinch fastener and a head cooperating with the shaft, the head having an outer periphery. A plurality of ribs disposed under the head to engage the workpiece upon installation of the clinch fastener to the workpiece, each of the plurality of ribs, extending radially outward in a direction from a displacement collar positioned proximate the central axis of the clinch fastener to the outer periphery of the head of the clinch fastener, comprises a non-flat surface having a curved surface and a parametric profile.

The clinch fastener includes a retaining ring cooperating with the shaft and a retaining groove cooperating with the shaft positioned between the displacement collar and retaining ring. Each of the plurality of ribs commences with a section that is perpendicular to the central axis of the clinch fastener, and a remainder of each of the plurality of ribs comprises a plurality of sections, wherein at least two of the sections are curved and defined by different radii or a plurality of line segments. The plurality of ribs and displacement collar are configured to radially displace workplace material into the retaining groove and diffuse stress within the workpiece material when the fastener is secured to the workpiece.

An aspect of the disclosure includes each of the ribs diminish in height and increase in width as each of the ribs extends in a direction going from the central axis of the clinch fastener to the outer periphery of the head of the clinch fastener.

In yet another aspect of the disclosure includes each of the ribs diminish in height and remain uniform in width as each of the ribs extends in a direction going from the central axis of the clinch fastener to the outer periphery of the head of the clinch fastener.

Another aspect of the disclosure includes the plurality of ribs are configured to provide for reduced warping of the workpiece material during installation as a result of the plurality of ribs being configured to provide for radially focused material displacement of workpiece material resulting from a taper on a sidewall of each of the ribs.

Yet another aspect of the disclosure includes the plurality of ribs are configured to provide a substantially circular recess in the workpiece material upon installation of the fastener on the workpiece material as a result of the plurality of ribs being configured to provide for radially focused material displacement of workpiece material resulting from a taper on a sidewall of each of the ribs and inward material flow from the retaining ring into the retaining groove.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more aspects of the disclosure will now be described, by way of example, with reference to the accompanying drawings, in which:

FIG. 1 is a bottom view of a prior art clinch fastener, in accordance with the disclosure;

FIG. 2 is a bottom, perspective view of the prior art clinch fastener shown in FIG. 1, in accordance with the disclosure;

FIG. 3 is a cross sectional view taken along line 3-3 of FIG. 4, another prior art fastener, in accordance with the disclosure;

FIG. 4 is a bottom, perspective view of the prior art clinch fastener shown in FIG. 3, in accordance with the disclosure;

FIG. 5 is a partial cross-sectional view (in the form of a Finite Element Analysis diagram) showing the prior art clinch fastener of FIGS. 3 and 4, after the clinch fastener has been installed relative to a workpiece (i.e., the host material), in accordance with the disclosure;

FIG. 6 is a side view of a clinch fastener in the form of a stud, wherein the clinch fastener is in accordance with an aspect of the disclosure;

FIG. 7 is a bottom, perspective view of the clinch fastener shown in FIG. 6, in accordance with the disclosure;

FIG. 8 is a bottom view of the clinch fastener shown in FIGS. 6 and 7, in accordance with the disclosure;

FIG. 9 is a cross-sectional view of the clinch fastener shown in FIGS. 6-8, taken along line 9-9 of FIG. 6, in accordance with the disclosure;

FIG. 10 is a partial cross-sectional view (in the form of a Finite Element Analysis diagram) showing the clinch fastener of FIGS. 6-9, after the clinch fastener has been installed relative to a workpiece (i.e., the host material), in accordance with the disclosure;

FIG. 11 is effectively the boxed portion 57 of FIG. 9, after the clinch fastener has been installed relative to a workpiece (i.e., the host material), annotated for discussion purposes, in accordance with the disclosure;

FIG. 12 is a cross-sectional view of the clinch fastener shown in FIG. 8, taken along line 12-12 in FIG. 8, in accordance with the disclosure;

FIG. 13 is bottom, perspective view much like FIG. 6, but where instead of being in the form of a stud, the fastener is in the form of a nut, in accordance with the disclosure;

FIG. 14, is a perspective view of the clinch fastener showing the workpiece material received and engaged by one or more of the plurality of ribs on the head of the clinch fastener, in accordance with the disclosure;

FIG. 15 is a perspective view of the clinch fastener showing the workpiece material received and engaged between one or more of the plurality of ribs on the head of the clinch fastener, in accordance with the disclosure;

FIG. 16 is a side plan view of the clinch fastener engaged with the workpiece material, in accordance with the present disclosure;

FIG. 17 is a sectional view of the clinch fastener engaged with the workpiece material along line 16-16 of FIG. 16, in accordance with the present disclosure;

FIG. 18A is a sectional view of the clinch fastener engaged with the workpiece material prior to installation along line 17-17 of FIG. 17, in accordance with the present disclosure;

FIG. 18B is a sectional view of the clinch fastener engaged with the workpiece material at a first installation position along line 17-17 of FIG. 17, in accordance with the present disclosure;

FIG. 18C is a sectional view of the clinch fastener engaged with the workpiece material at a second installation position along line 17-17 of FIG. 17, in accordance with the present disclosure; and

FIG. 18D is a sectional view of the clinch fastener engaged with the workpiece material at a final installation position along line 17-17 of FIG. 17, in accordance with the present disclosure.

The appended drawings are not necessarily to scale, and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail to avoid unnecessarily obscuring the disclosure. Furthermore, the disclosure, as illustrated and described herein, may be practiced in the absence of an element that is not specifically disclosed herein.

The following detailed description is merely exemplary in nature and is not intended to limit the application and uses. Furthermore, there is no intention to be bound by any expressed or implied theory presented herein. Throughout the drawings, corresponding reference numerals indicate like or corresponding parts and features. The use of ordinals such as first, second and third does not necessarily imply a ranked sense of order, but rather may only distinguish between multiple instances of an act or structure.

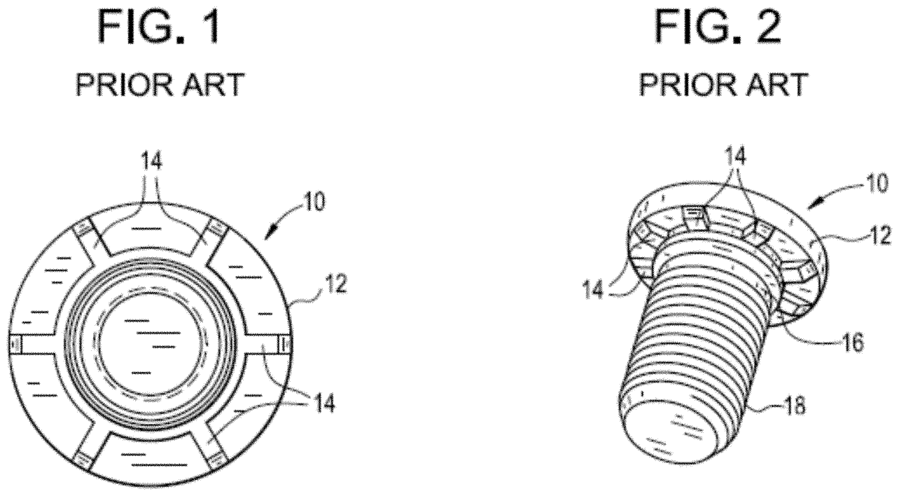

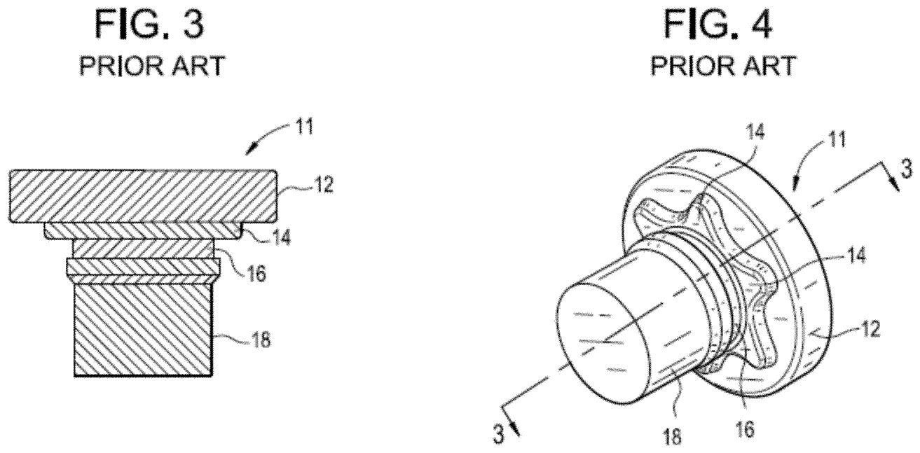

FIGS. 1-2 illustrate a prior art clinch fastener 10 that is consistent with that which is disclosed in U.S. Pat. No. 5,513,933. Specifically, FIG. 1 is a bottom view thereof, and FIG. 2 is a bottom, perspective view thereof. FIGS. 3 and 4 illustrate another type of prior art clinch fastener 11. Specifically, FIG. 3 is a bottom view thereof, and FIG. 4 is a bottom, perspective view thereof. Both prior art fasteners 10 and 11, shown in FIGS. 1-4, include a head 12, straight or flat ribs 14 under the head 12, an annular recess 16 proximate the ribs 14, and a shaft 18.

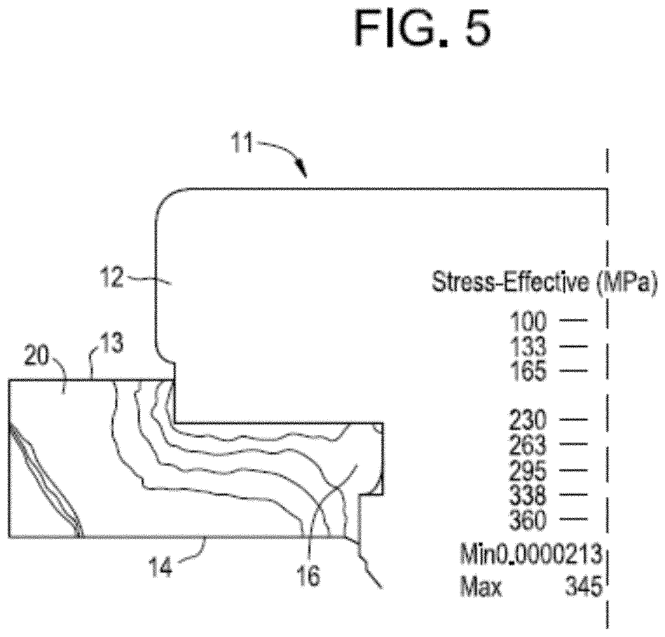

Although both fasteners 10 and 11 include straight or flat ribs 14 and either fastener 10 or 11 can be used for explanation purposes, for the sake of example, FIG. 5 is a partial cross-sectional view (in the form of a Finite Element Analysis diagram) showing the prior art clinch fastener 11 of FIGS. 3 and 4, after the clinch fastener has been installed relative to a workpiece 20 (i.e., the host material). FIG. 5 shows that, when installed, the straight rib 14 displaces an excess of the host material causing the host material to cold flow into the annular recess 16. This causes high stress areas in the host material 20 under the head 12 of the clinch fastener 11 because the material is confined by the shape of the rib, wherein the material is prevented from flowing both radially outward and perpendicular to the rib. This could result in warping of the workpiece 20 (i.e., wherein the surface of the workpiece 20 deforms next to the clinch fastener 11, such as in area 13), the clinch fastener 11 not being perpendicular to the workpiece 20 after installation, as well as other, undesirable traits with regard to the joint. For example, the configuration of each of the ribs 14 tends to displace workpiece material in a direction toward the adjacent ribs, causing increased stress between the ribs 14.

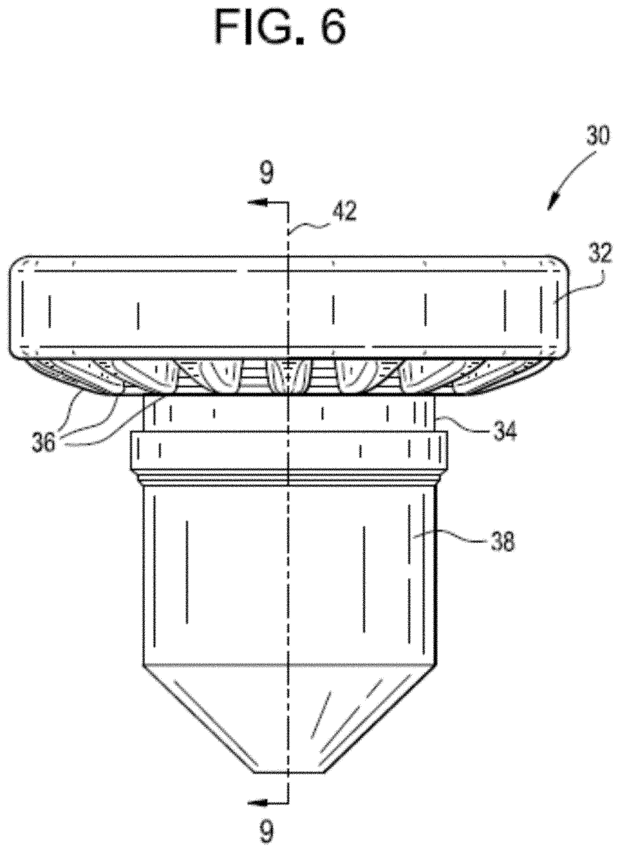

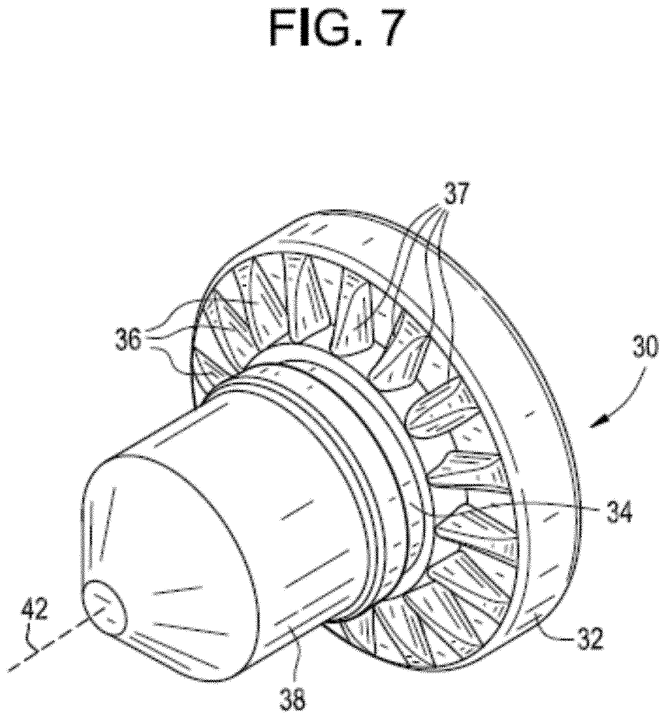

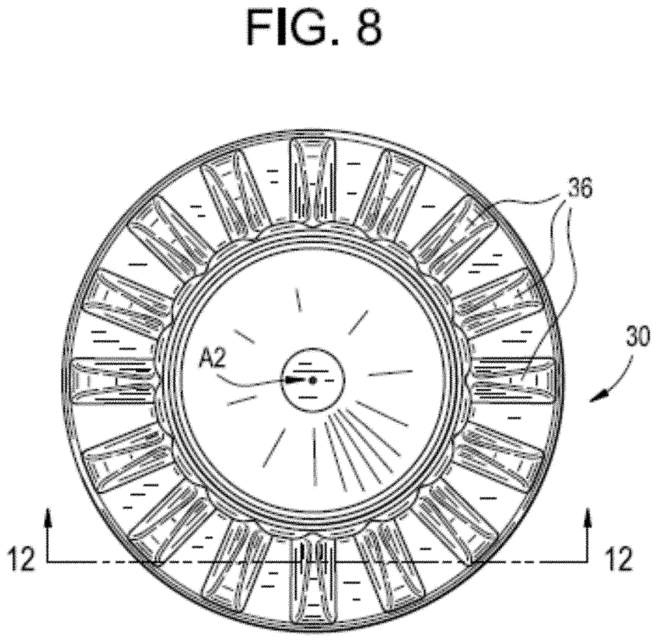

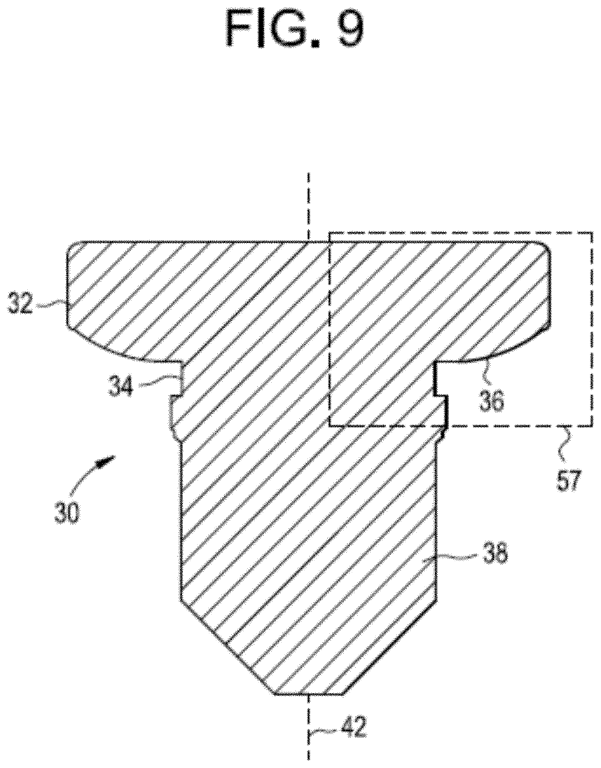

Referring to the drawings, wherein like reference numerals correspond to like or similar components throughout the several FIGS., FIGS. 6-8, consistent with embodiments disclosed herein, illustrates elements of an embodiment of a clinch fastener 30 in accordance with an aspect of the disclosure. FIG. 9 is a cross-sectional view of the clinch fastener 30 shown in FIGS. 6-8, taken along line 9-9 of FIG. 6). As shown, the clinch fastener 30 is similar to the clinch fasteners 10 and 11 shown in FIGS. 1-4 and includes a head 32, an annular recess or retaining groove 34 proximate ribs 36, and a shaft 38. However, the clinch fastener 30 shown in FIGS. 6-9 includes ribs 36 under the head 32 that are specifically configured to displace host material more evenly than conventional clinch fasteners, such as the clinch fasteners 10 and 11 shown in FIGS. 1-4. As shown in FIGS. 7 and 8, preferably the ribs 36 are equally spaced apart under the head 32, but that is not imperative. As shown in, for example, FIGS. 7, 8 and 12, the side walls 37 of each of the ribs 36 could be tapered (while the sidewalls are shown as being outwardly tapered (i.e., in relation the adjacent rib 36), they could be provided as being inwardly tapered instead).

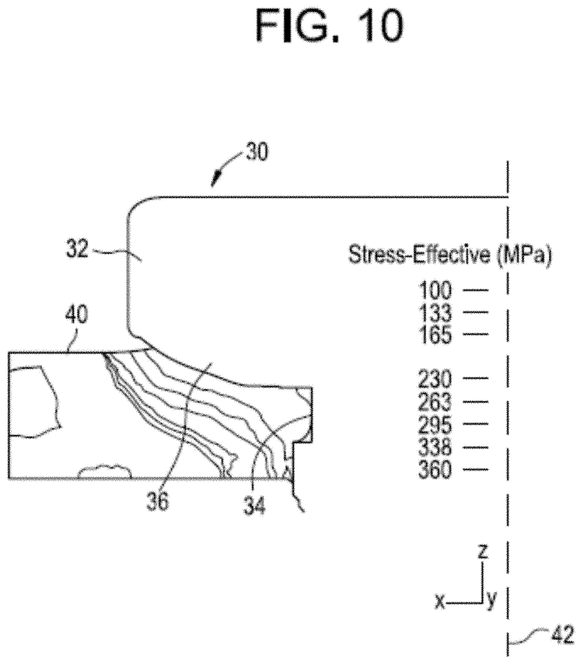

FIG. 10 is a partial cross-sectional view (in the form of a Finite Element Analysis diagram) showing a portion of the clinch fastener 30 of FIGS. 6-9 after the clinch fastener 30 has been installed relative to a workpiece 40 (i.e., the host material). As shown, the clinch fastener 30, as a result of having the special ribs 36, provides a more uniform stress distribution in the host material compared to what is shown in FIG. 5 with regard to the corresponding prior art clinch fastener 11. Each of the special ribs 36, given its shape and configuration, tends to displace the workpiece material outward, as opposed to a direction toward adjacent ribs. As such, stress is minimized between the ribs.

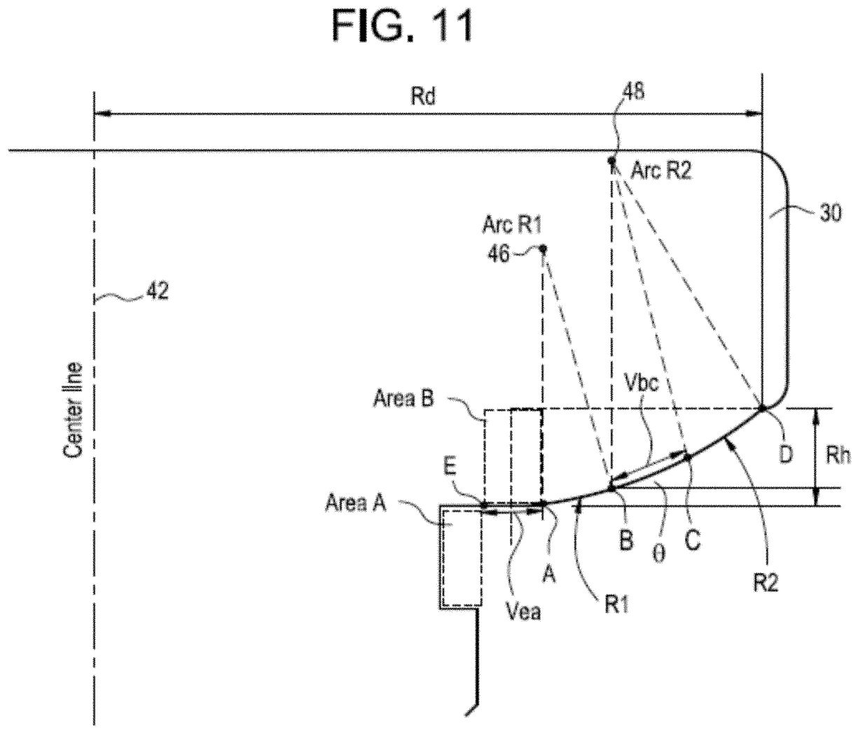

Preferably, each rib 36 of the clinch fastener 30 is effectively identical. The ribs 36 of the clinch fastener 30 shown in FIGS. 6-10 will now be described in more detail with reference to FIG. 11. FIG. 11 is effectively the boxed portion 57 of FIG. 9, annotated for discussion purposes, and showing the clinch fastener 30 after the clinch fastener 30 has been installed relative to a workpiece (i.e., the host material). In FIG. 11, “Area A” is effectively the area of the recess defined by a predetermined height and width based on preferred performance of the retaining groove 34 that is configured to receive cold flow of host material 40 during installation of the clinch fastener 30. Preferably, the height and width of “Area A” is dictated by standards, and the flow factor is dictated by the ductility of the host material 40 to which the clinch fastener 30 is staked during installation (i.e., the greater the ductility of the host material, the higher the flow factor). The dimension “Rh” is effectively the height of each rib 36 at its highest point, and that dimension is also preferably dictated by workpiece thickness. The dimension “Rd” is effectively the distance from the central axis 42 of the clinch fastener 30 to the end of each rib 36 (the central axis 42 is also identified in FIGS. 6-10). That dimension is preferably dictated by embedment and pull through requirements.

As shown in FIG. 11, in cross section, along a line going from a central axis 42 of the clinch fastener 30 to an outer periphery of the head 32 of the clinch fastener 30 (i.e., to the end of each rib 36), each rib 36 is formed of multiple sections. As shown in FIG. 11, preferably the ribs 36 diminish in height as they extend toward (but not necessarily all the way to) the outermost periphery of the head 32 of the clinch fastener 30. Preferably, each rib 36 commences with a section that is perpendicular (or at least substantially perpendicular) to the central axis 42 of the clinch fastener 30. As shown in FIG. 11, this section goes from point E (i.e., the corner of the recess) to Point A, and is identified as vector “Vea.” The area “Area B” is a product of both the height of each rib 36 at its highest point (“Rh”) and “Vea” (i.e., the distance from point E to point A). Also, “Area A”=“Area B” multiplied by the flow factor.

As such,
“Area B”=“Rh” multiplied by “Vea”;
“Vea”=“Area B”/“Rh”; and
“Vea”=(“Area A”/the flow factor)/“Rh”

The remainder of rib 36 is preferably a plurality of sections at least two of which are curved sections defined by different radii or a plurality of short line segments. Preferably, one section extends from point A to point B as shown in FIG. 11, and is defined by a radius identified in FIG. 11 as “Arc R1”. Preferably, the focal point 46 or center of “Arc R1” coincides vertically (i.e., parallel to the central axis 42 of the clinch fastener 30) with point A, and the radius of the arc is approximately 10-60 degrees and is dictated by fastener size.

Preferably, another section extends from point B to point C (defined as vector Vbc) as shown in FIG. 11, and is substantially flat or straight (or may be provided as being arcuate). This starts at point B when the Arc R1 slope from horizontal equals Theta. Arc R1 and Vbc are tangent at point B. Then point C has a linear relationship to point B and is defined by linear equation based on endpoints B and C in FIG. 11. The horizontal dimension of point C from the center axis is directly related to the position of point D and Arc R2.

Yet another section extends from point C to point D (i.e., the outer end of the rib 36) as shown in FIG. 11 and is defined by a radius identified in FIG. 11 as “Arc R2”. Preferably, the focal point 48 or center of “Arc R2” coincides vertically (i.e., parallel to the central axis 42 of the clinch fastener 30) with point B, and the radius of the arc is approximately 10-60 degrees. Preferably, “Arc R2” starts at point C and ends at point D (i.e., the outer end of the rib 36). Preferably, the focal points 46, 48 or centers of “Arc R1” and “Arc R2” (i.e., their vertical locations meaning how far they are from points A and B, respectively) depend on “Rh” and “Point D,” and the profile of the rib 36 is fully constrained going from point A to point D.

Thus, the plurality of sections of the rib form a parametric profile of the rib, wherein the parametric profile of the rib is further defined by the parameters including the rib height, the distance from the central axis of the fastener to the end of the rib, and the predefined angle Theta as shown in FIG. 11.

FIG. 12 is a cross-sectional view of the clinch fastener 30 shown in FIG. 8, taken along line 12-12 in FIG. 8. As shown, preferably the sides 37 of the ribs 36 are tapered or sloped, such as at an angle alpha, which can vary based on manufacturing tolerances that occur during rib formation. In an aspect of the disclosure, for illustrative purposes only shown in FIG. 12, alpha is a twenty degree angle (included, meaning both sides) angle (for example), such that the slope of the sides 37 of the ribs 36 facilitate the flow of workpiece material between the ribs 36 during staking of the clinch fastener 30.

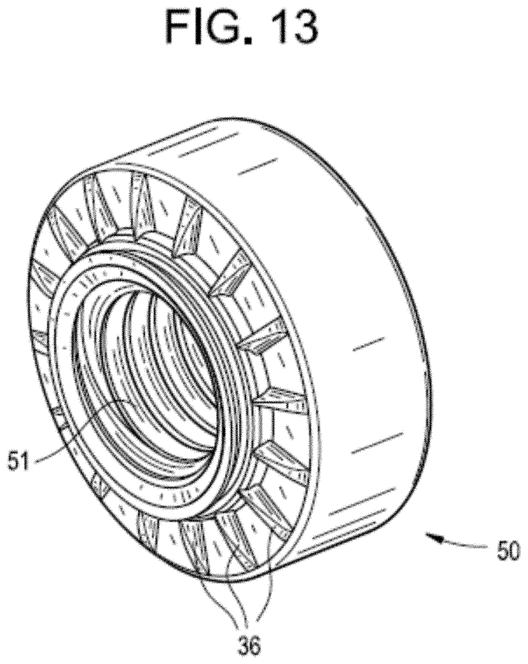

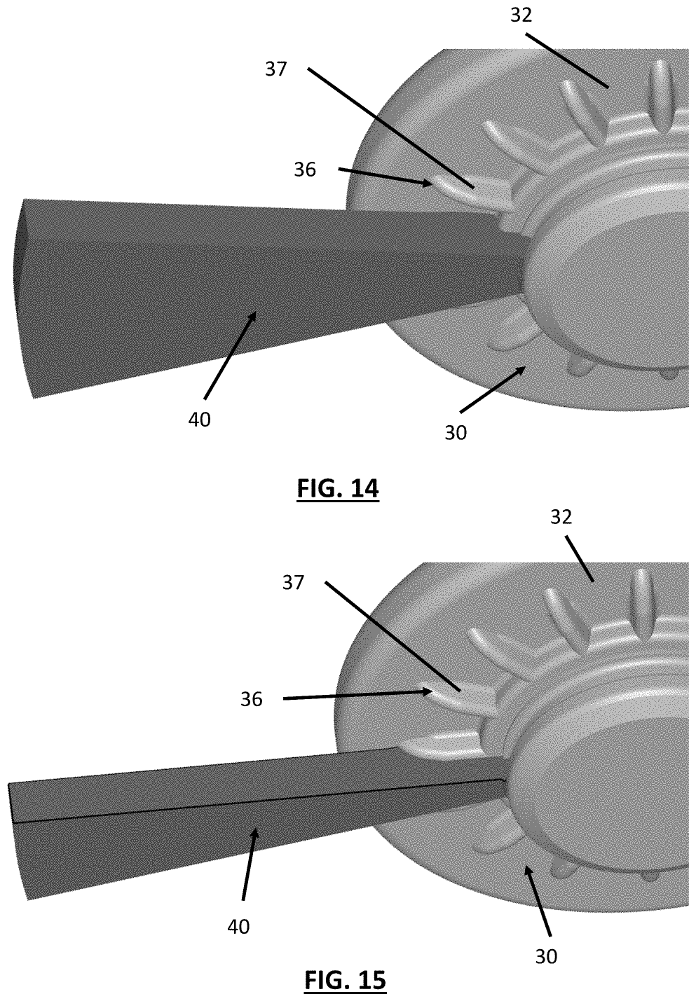

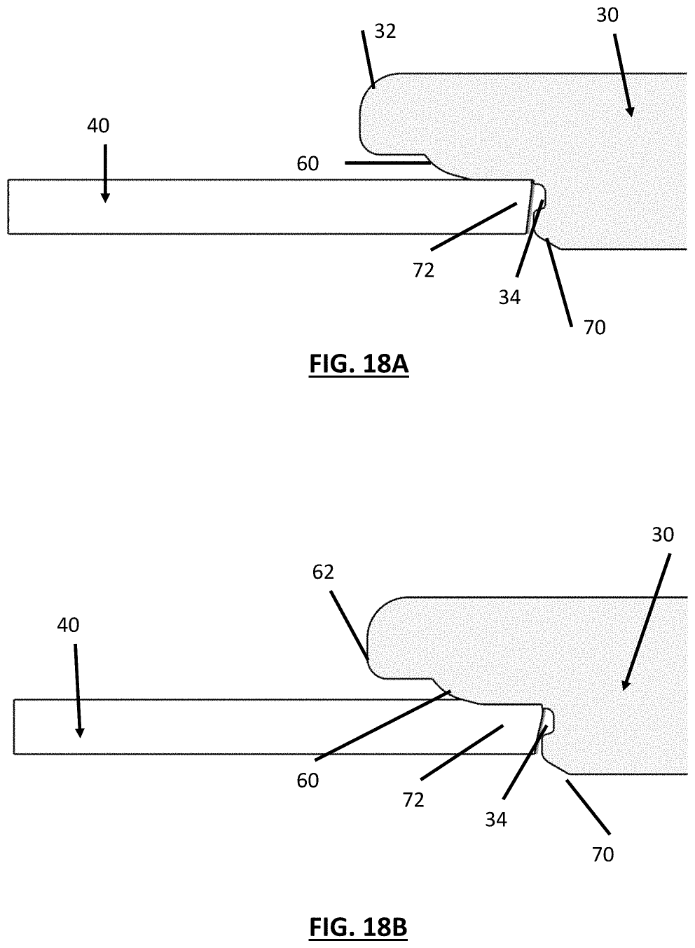

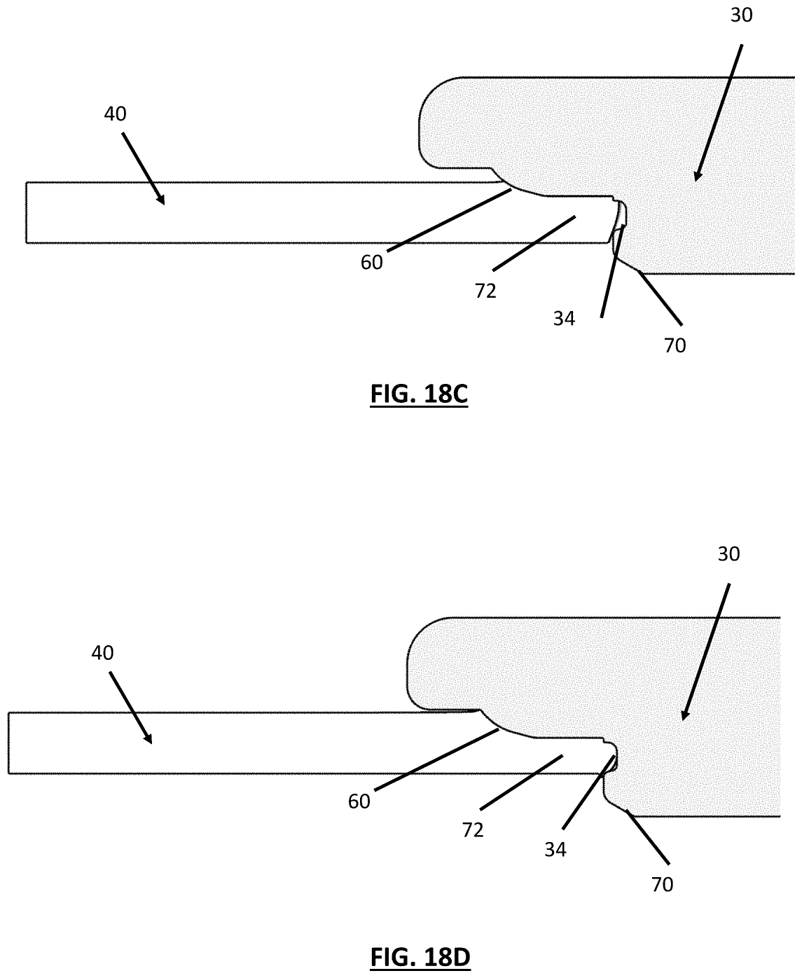

The configuration of the ribs 36 provides for radially focused material displacement, thereby diffusing stress within the sheet material 40 and reducing warping during clinching. Preferably, the ribs 36 of the clinch fastener 30 are optimized to match the torsional stress distribution by decreasing the amount of sheet material while maximizing torsional (blind hole failure torque) of the clinch fastener 30. The configuration of the ribs 36 minimizes the volume of the rib profile radially outward as the force on the rib increases as torque is applied after staking, thereby creating a more uniform stress distribution on the rib as best shown in FIGS. 14 and 15. It is understood that the ribs 36 may be equally spaced apart under the head 32 of the fastener 30, or, in the alternative, the ribs 36 may be unequally spaced apart under the head 32 of the fastener 30. The profile of the ribs 36 under the head 32 of the fastener 30 prevents rotation of the fastener 30 after being staked into the workpiece 40 as shown in FIG. 18A.

The specially designed curved-shaped rib also allows for a vented escape of sheet material beyond the rib outside diameter. In contrast, conventional rib designs cause the sheet material to be contained and not vented. While a rib design which is in accordance with an aspect of the disclosure is not limited to being used only with soft joint materials, the rib design is ideal for use with soft joint materials (i.e., such as with aluminum, etc.).

A rib design which is in accordance with an aspect of the disclosure allows for the use a high strength clinch nut and stud, even in connection with soft joint materials. The rib configuration could even result in thinner sheet material being able to be used. The rib configuration causes less distortion of the sheet material resulting in a flatter seating area, and results in the clinch fastener being more perpendicular to the sheet material after installation. Using the clinch fastener disclosed herein results in reduced warping between installed clinch fasteners, and the installation holes have less distortion before and after assembly.

The rib configuration reduces the distance needed between holes and reduces edge effects during installation. The rib configuration results in reduced distortion of the sheet material, which results in less distortion of the hole and better performance. The rib configuration allows for the use of higher staking force, without running the risk of deforming the mating materials surface and allowing for the clinching of thinner materials. The rib configuration also allows the fastener to be staked at a higher force to ensure proper seating of the fastener.

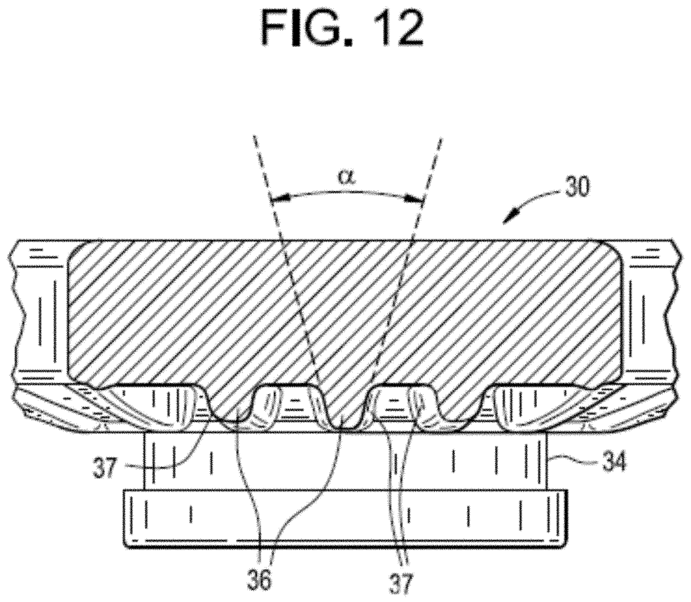

While FIGS. 6-12 illustrate one aspect of the disclosure in the form of a stud, the disclosure can be employed in many other aspects, such as in the form of a nut 50 (having a threaded bore 51) as shown in FIG. 13 which includes the ribs 36 that have been described hereinabove. Still other aspects are entirely possible while still staying very much within the scope of the disclosure. Additionally, despite a specific number of ribs 36 being depicted herein, any number of ribs be provided on a given fastener while still staying very much within the scope of the disclosure.

In one aspect of the disclosure, each of the ribs 36 diminish in height and increase in width as each of the ribs 36 extends in a direction going from the central axis 42 of the clinch fastener 30 to the outer periphery 62 of the head 30 of the clinch fastener 30. In yet another aspect of the disclosure includes each of the ribs 36 diminish in height and remain uniform in width as each of the ribs extends in a direction going from the central axis 42 of the clinch fastener 30 to the outer periphery of the head 32 of the clinch fastener 30. It is understood that the rib profile that may increase in width as it moves radially outward plus a constant, variable, and ranged radii (max/min as the rib progresses moving radially outward.

Still further, while the rib 36 has been described as preferably comprising a plurality of sections at least two of which are curved sections defined by different radii, the rib 36 can instead comprise a plurality of flat sections that collectively provide that the rib 36 gradually diminishes in height as it extends to its outer periphery (i.e., to the end of the rib 36). It is also understood that the top of one or more of the plurality of ribs 36 may include a rounded edge of a radius of varying tolerances to enhance securement of the clinch fastener to the workpiece material.

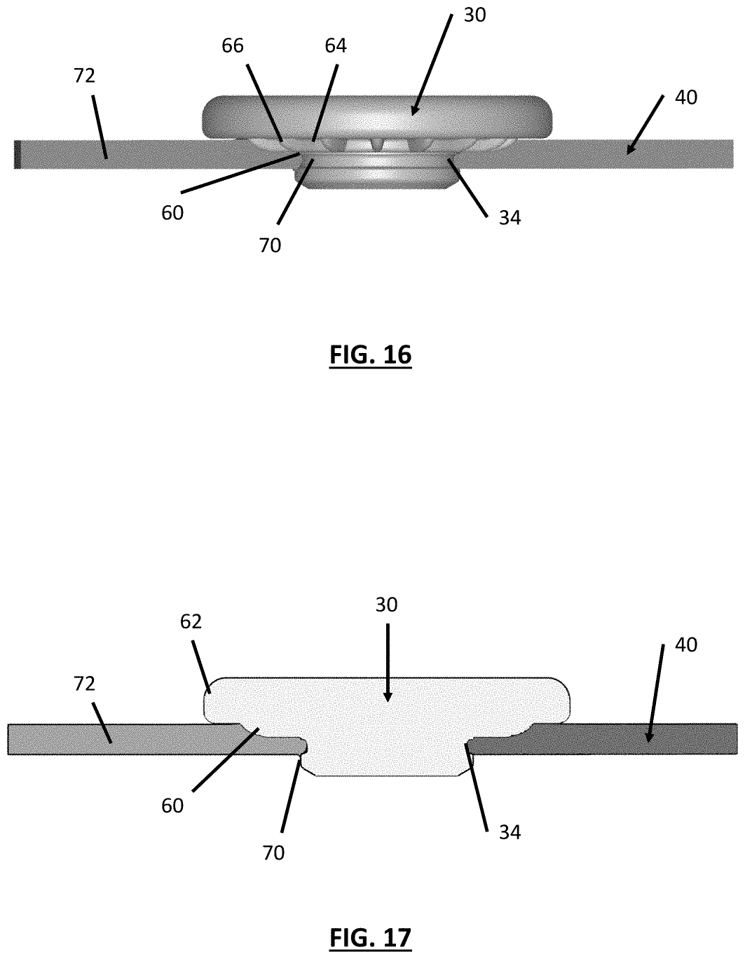

Referring now to FIGS. 16-18, the clinch fastener 30 is shown prior to and installed relative to a workpiece 40 is illustrated and described. The clinch fastener 30 is configured to provide for a more uniform stress distribution in the workpiece 40 upon installation thereon. Clinch fastener 30 includes a plurality of ribs 36 disposed under the head 32 to engage the workpiece 40 upon installation of the clinch fastener 30 to the workpiece 40. The plurality of ribs extend radially outward in a direction from a displacement collar 60 positioned proximate the central axis 42 of the clinch fastener 30 to the outer periphery 62 of the head 32. The displacement collar 60 cooperates with the plurality of ribs 36 to displace and direct workpiece material into the retaining groove 34 as shown in FIG. 18B.

As discussed above, each of the plurality of ribs 36 includes multiple sections forming at least a sidewall 37 and a parametric profile for each rib 36, including at least a first section 64 disposed proximate the displacement collar 60 and shaft 38 and extending perpendicular to the central axis 42 and an outer end 66 adjacent the outer periphery 62 of the head 32. The parametric or arcuate radial rib profile causes the workpiece material 72 to progressive material flow radially outward along the sidewalls 37 and periphery of the ribs 36, resulting in reduction of stress during installation of the fastener 30 on the workpiece 40, thereby minimizing deformation of workpiece material 72. Additionally, a symmetric rib taper angle causes workpiece material 72 to flow generally perpendicularly inward between the ribs 36, thereby reducing circumferential stress between the ribs 36.

A retaining ring 70 is disposed on shaft 38 proximate the retaining groove 34 and displacement collar 60. In one aspect of the disclosure, the displacement collar 60 is positioned adjacent and above the retaining groove 34 while the retaining ring 70 is positioned adjacent and below the retaining groove 34. It is understood that alternative configurations and positions of the displacement collar 60, retaining groove 34 and retaining ring 70 are also contemplated by this disclosure.

As shown in FIGS. 18A-18D, the retaining ring 70 is sized and positioned to cooperate with the retaining groove 34 to direct displaced material 72 from the workpiece 40 and provide a boundary or barrier to limit travel of the displaced material 72 during installation of the clinch fastener 30 on the workpiece 40. The plurality of ribs 36 and displacement collar 60 are configured to radially displace workplace material 72 into the retaining groove 34 and diffuse stress within the workpiece material when the clinch fastener 30 is secured to the workpiece 40.

Another aspect of the disclosure includes the plurality of ribs 36 configured to provide for reduced warping of the workpiece material 72 during installation as a result of the plurality of ribs 36 being configured to provide for radially focused material displacement of workpiece material resulting from a taper on a sidewall 37 of each of the ribs 36. In yet another aspect of the disclosure, the plurality of ribs 36 are configured to provide a substantially circular recess in the workpiece material 72 upon installation of the fastener 30 on the workpiece 40 as a result of the plurality of ribs 36 being configured to provide for radially focused material displacement of workpiece material 72 resulting from a taper on a sidewall 37 of each of the ribs 36 and inward flow of workpiece material 72 from the retaining ring 70 into the retaining groove 34.

While specific aspects of the disclosure have been shown and described, it is envisioned that those skilled in the art may devise various modifications without departing from the spirit and scope of the disclosure. For example, while the aspects have been described and depicted as being round in shape and being used with round holes, obround versions are totally possible for use with obround holes while still staying very much within the scope of the disclosure.

The detailed description and the drawings or figures are supportive and descriptive of the present teachings, but the scope of the present teachings is defined solely by the claims. While some of the best modes and other aspects for carrying out the present teachings have been described in detail, various alternative designs and embodiments exist for practicing the present teachings defined in the claims.

What is claimed is:

1. A clinch fastener for installation relative to a workpiece, the clinch fastener comprising:
a shaft defining a central axis of the clinch fastener;
a head cooperating with the shaft, the head having an outer periphery;
a plurality of ribs disposed under the head to engage the workpiece upon installation of the clinch fastener to the workpiece, the plurality of ribs extending radially outward in a direction from a displacement collar positioned proximate the central axis of the clinch fastener to the outer periphery of the head, wherein each of the plurality of ribs includes multiple sections forming at least a sidewall and a parametric profile for each rib, including at least a first section disposed proximate the shaft extending perpendicular to the central axis and an outer end adjacent the outer periphery of the head;
a retaining ring cooperating with the shaft; and
a retaining groove cooperating with the shaft positioned between the displacement collar and retaining ring,
wherein the plurality of ribs and displacement collar are configured to radially displace workplace material into the retaining groove and diffuse stress within the workpiece material when the fastener is secured to the workpiece.

2. The clinch fastener as recited in claim 1, wherein at least two of the sections are defined by different radii or a plurality of line segments.

3. The clinch fastener as recited in claim 1, wherein at least two of the sections are flat, and at least one is parallel to the head.

4. The clinch fastener as recited in claim 1, wherein each of the ribs diminish in height as each of the ribs extends in a direction going from the central axis of the clinch fastener to the outer periphery of the head of the clinch fastener.

5. The clinch fastener as recited in claim 1, wherein the ribs are equally spaced apart under the head.

6. The clinch fastener as recited in claim 1, wherein the ribs are unequally spaced apart under the head.

7. The clinch fastener as recited in claim 1, wherein the retaining groove is positioned proximate the plurality of ribs under the head, and includes an annular recess proximate the ribs, disposed between the head and the shaft.

8. The clinch fastener as recited in claim 1, wherein the clinch fastener comprises a nut having a threaded bore.

9. The clinch fastener as recited in claim 1, wherein each of the plurality of ribs commences with a section that is perpendicular to the central axis of the clinch fastener, and a remainder of each rib comprises a plurality of sections, wherein at least two of the sections are curved and defined by different radii or a plurality of line segments.

10. The clinch fastener as recited in claim 1, wherein each of the plurality of ribs commences with a section that is perpendicular to the central axis of the clinch fastener, wherein each rib has at least one section that is curved and one section that is flat.

11. The clinch fastener as recited in claim 1, wherein each of the plurality of ribs comprises a plurality of flat sections that collectively provide that the rib diminishes in height as the rib extends to the outer periphery of the head.

12. The clinch fastener as recited in claim 1, wherein each of the plurality of ribs comprises tapered sidewalls.

13. The clinch fastener as recited in claim 1, wherein each of the plurality of ribs comprises outwardly tapered sidewalls.

14. The clinch fastener as recited in claim 1, wherein the plurality of ribs are configured to provide for reduced warping of the workpiece material during installation as a result of the plurality of ribs being configured to provide for radially focused material displacement of workpiece material resulting from a taper on a sidewall of each of the ribs.

15. The clinch fastener as recited in claim 1, wherein each of the plurality of ribs commences with a section that is perpendicular to the central axis of the clinch fastener, and a remainder of each rib comprises a plurality of sections, and wherein the plurality of sections form the parametric profile of the plurality of ribs.

16. The clinch fastener as recited in claim 14, wherein the parametric profile of each of the plurality of ribs is defined by a plurality of parameters including a rib height, a distance from a central axis of the clinch fastener to an end of the rib, and a predefined angle Theta.

17. A clinch fastener for installation relative to a workpiece, the clinch fastener comprising:
a shaft defining a central axis of the clinch fastener;
a head cooperating with the shaft, the head having an outer periphery;
a plurality of ribs disposed under the head to engage the workpiece upon installation of the clinch fastener to the workpiece, wherein each of the plurality of ribs, extending radially outward in a direction from a displacement collar positioned proximate the central axis of the clinch fastener to the outer periphery of the head of the clinch fastener, comprises a non-flat surface having a curved surface and a parametric profile;
a retaining ring cooperating with the shaft; and
a retaining groove cooperating with the shaft positioned between the displacement collar and retaining ring,
wherein each of the plurality of ribs commences with a section that is perpendicular to the central axis of the clinch fastener, and a remainder of each of the plurality of ribs comprises a plurality of sections, wherein at least two of the sections are curved and defined by different radii or a plurality of line segments,
wherein the plurality of ribs and displacement collar are configured to radially displace workplace material into the retaining groove and diffuse stress within the workpiece material when the fastener is secured to the workpiece.

18. The clinch fastener as recited in claim 15, wherein each of the ribs diminish in height as each of the ribs extends in a direction going from the central axis of the clinch fastener to the outer periphery of the head of the clinch fastener.

19. A clinch fastener as recited in claim 15, wherein the plurality of ribs are configured to provide for reduced warping of the workpiece material during installation as a result of the plurality of ribs being configured to provide for radially focused material displacement of workpiece material resulting from a taper on a sidewall of each of the ribs.

20. The clinch fastener as recited in claim 1, wherein the plurality of ribs are configured to provide a substantially circular recess in the workpiece material upon installation of the fastener on the workpiece material as a result of the plurality of ribs being configured to provide for radially focused material displacement of workpiece material resulting from a taper on a sidewall of each of the ribs and inward material flow from the retaining ring into the retaining groove.
